(19) United States
(12) Patent Application Publication
(10) Pub. No.: US 2014/0308625 A1
(43) Pub. Date: Oct. 16, 2014

(54) DEVICE FOR DELIVERY OF A TOOTH WHITENING AGENT

(71) Applicant: KONINKLIJKE PHILIPS N.V., ENDHOVEN (NL)

(72) Inventors: Peter Douglas Fairley, Plymouth (GB); David Andrew Fish, Haywards Heath (GB); Bart Gottenbos, Budel (NL); Nigel David Young, Meadvale (GB); Veena Mohan, Cambridge (GB)

(73) Assignee: KONINKLIJKE PHILIPS N.V., Eindhoven (NL)

(21) Appl. No.: 14/365,787

(22) PCT Filed: Dec. 19, 2012
(86) PCT No.: PCT/IB2012/057478

§ 371 Date: Jun. 16, 2014

Related U.S. Application Data
(60) Provisional application No. 61/579,709, filed on Dec. 23, 2011.

(51) Int. Cl. A61C 17/028; A61C 19/06

(52) U.S. Cl. CPC A61C 17/028; A61C 19/066
USPC 433/88; 433/217.1

(57) ABSTRACT

A delivery device (12) includes a source (16) of pressurized fluid, a nozzle (24, 16) which defines an outlet (22), a pathway (20) which fluidly connects the source of pressurized fluid with the nozzle outlet (22) for delivery of a spray of fluid from the nozzle outlet, and a receptacle (32), which receives a dose of particles (28). The receptacle is positioned in the pathway such that the dose of the particles is carried by the pressurized fluid and through the nozzle outlet, the particles including a tooth whitening agent.

The following relates to the dental cleaning arts, and related arts and more specifically concerns a system for delivering a dental care agent to the teeth, such as a tooth whitening agent for whitening the teeth.

Tooth whitening agents are generally hydrogen peroxide-based and the aim is generally to deliver the peroxide to the teeth in a sufficient amount to effect a color change in the surface of the teeth in an acceptable period of time without causing harm to the user. Various methods have been developed for applying tooth whitening agents to the teeth. These include toothpastes, peroxide gel strips, whitening solutions, and mouthwashes. Abrasive toothpastes, while easy to use, are generally ineffective. Peroxide gel strips are somewhat more effective, but entail wearing a plastic strip on the teeth to be treated for an extended period. Mouthwashes, which are solutions of peroxide, can be harmful due to contact of the solution with soft tissues. Dental trays use a high concentration of peroxide solution. As a result, great care is needed to avoid contact of the peroxide with soft tissue. Such methods are therefore best suited to use in a dental surgery.

Another problem with hydrogen peroxide is that it rapidly decomposes and becomes ineffective as a bleaching agent. Recently, methods have been developed for encapsulating carbamide peroxide, a dry source of hydrogen peroxide, which is an adduct of urea and hydrogen peroxide. See, Jing Xue and Zhibing Zhang, “Preparation and characterization of calcium-shellac spheres as a carrier of carbamide peroxide,” J. Microencapsulation 25(8), p. 523 (2008); and Jing Xue and Zhibing Zhang, “Physical, Structural and Mechanical Characterisation of Calcium-Shellac Microspheres as a Carrier of Carbamide Peroxide,” J. Applied Polymer Science, Vol. 113, p. 1619 (2009). Such spheres are suggested for being combined in a carrier material, such as a toothpaste or gum. However, moisture in the carrier material may cause the hydrogen peroxide to be released and decompose before the material is used for teeth whitening.

A device for delivery of a tooth whitening agent and a cartridge containing encapsulated whitening agent for use therewith are disclosed which can overcome some of the problems with existing delivery systems.

In accordance with one aspect of the invention, a delivery device includes a source of pressurized fluid, a nozzle which defines an outlet, a pathway which fluidly connects the source of pressurized fluid with the nozzle outlet for delivery of a spray of fluid from the nozzle outlet, and a receptacle, which receives a dose of particles. The receptacle is positioned in the pathway such that the dose of the particles is carried by the pressurized fluid and through the nozzle outlet in the spray. The particles include a dental care agent agent.

In another aspect, a method for delivery of particles includes inserting a dose of particles into a delivery device, the particles comprising a dental care agent. The delivery device is actuated to cause a flow of pressurized fluid to flow from a source of the pressurized fluid to the particles and transport the particles to a nozzle of the delivery device, whereby the particles are ejected from the device in a spray of the pressurized fluid.

In another aspect, a tooth whitening system includes a delivery device which includes a source of pressurized fluid, a nozzle which defines an outlet, and a pathway which fluidly connects the source of pressurized fluid with the nozzle outlet for delivery of a spray of fluid from the nozzle outlet. A cartridge holds a plurality of capsules, each capsule holding a single dose of particles. The particles include an encapsulated tooth whitening agent. The cartridge is mountable to the delivery device for inserting a cartridge into the pathway, such that when the device is actuated, the dose of the particles is carried by the pressurized fluid and through the nozzle outlet in the spray.

The invention may take form in various components and arrangements of components, and in various process operations and arrangements of process operations. The drawings are only for the purpose of illustrating preferred embodiments and are not to be construed as limiting the invention.

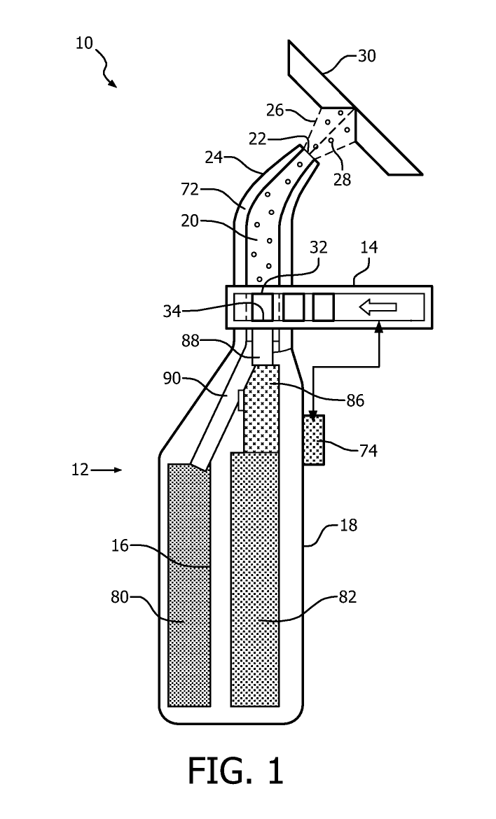

FIG. 1 diagrammatically shows, in partial cross section, a first embodiment of a delivery system for delivery of a tooth whitening agent;

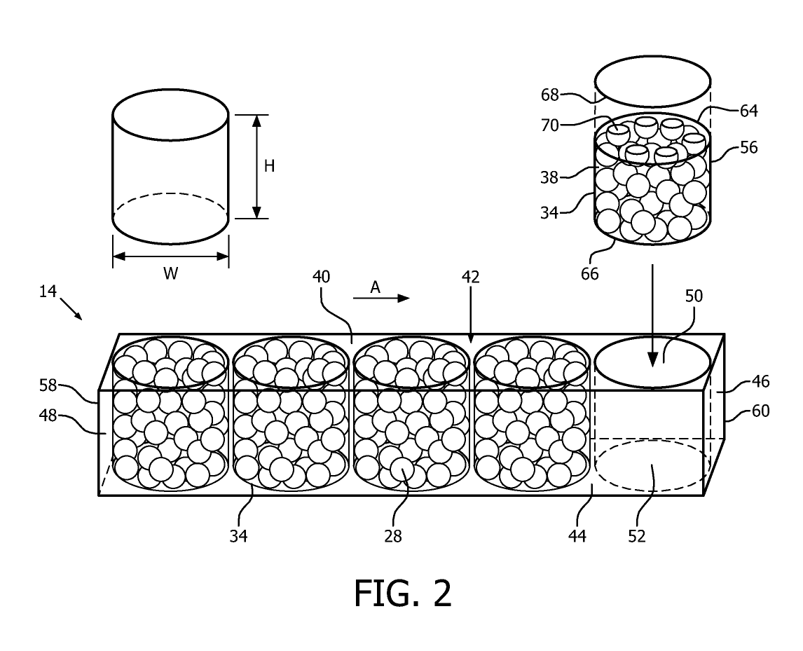

FIG. 2 diagrammatically shows a perspective view of a replaceable cartridge which holds an encapsulated whitening agent for use with a delivery device as shown in FIG. 1;

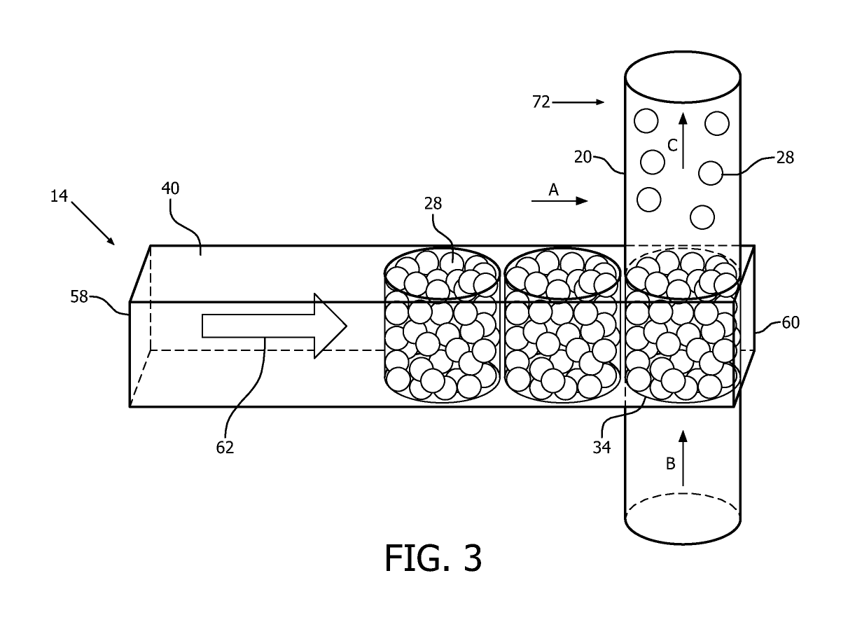

FIG. 3 diagrammatically shows a perspective view of the replaceable cartridge of FIG. 1 inserted in the fluid flow path of a delivery device;

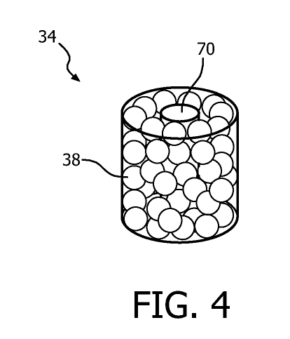

FIG. 4 diagrammatically shows a perspective view of another embodiment of a capsule for use in the replaceable cartridge of FIG. 2;

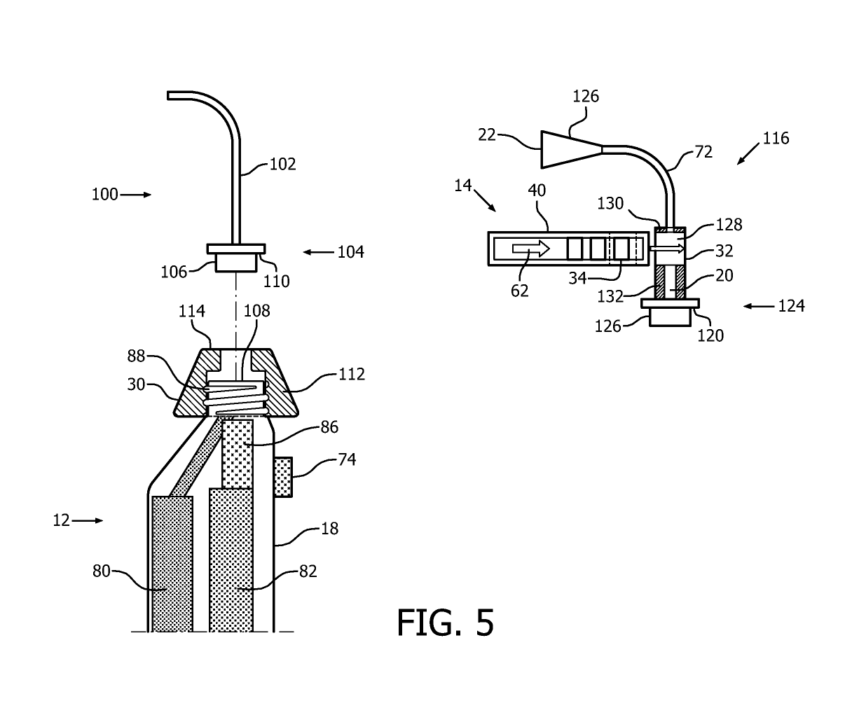

FIG. 5 diagrammatically shows, in partial cross section, a second embodiment of a delivery system for delivery of a tooth whitening agent;

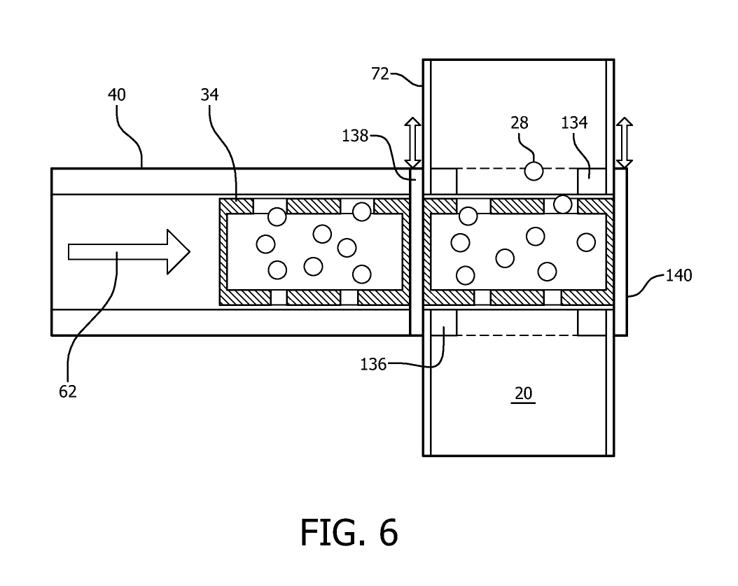

FIG. 6 diagrammatically shows a third embodiment of a delivery system for delivery of a tooth whitening agent;

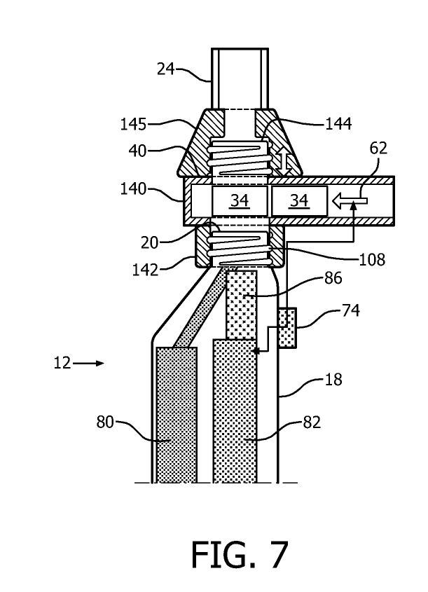

FIG. 7 diagrammatically shows a third embodiment of a delivery system for delivery of a tooth whitening agent;

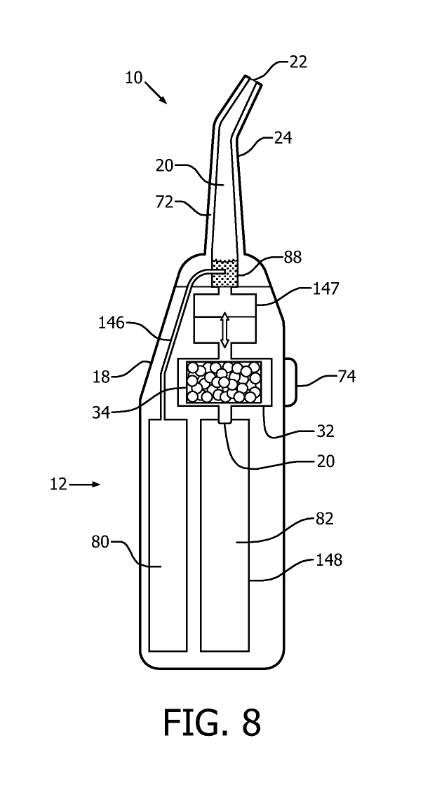

FIG. 8 diagrammatically shows a third embodiment of a delivery system for delivery of a tooth whitening agent; and

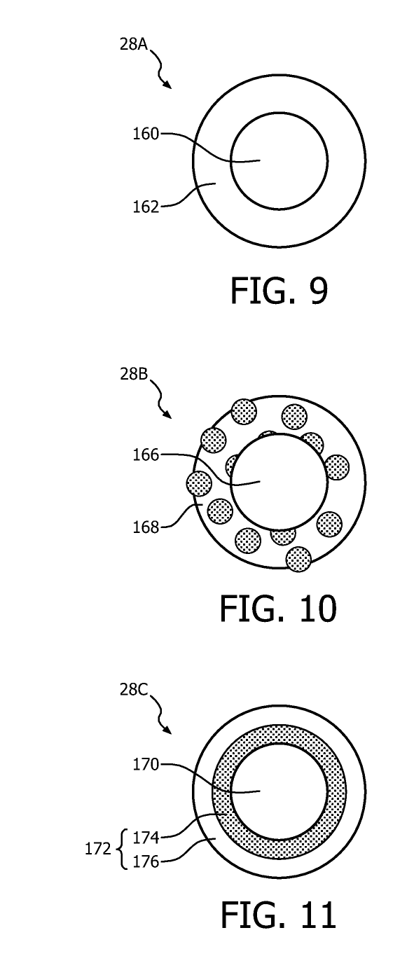

FIGS. 9-11 illustrate exemplary particles.

With reference to FIG. 1, a schematic cross sectional view of a delivery system 10 is shown. The delivery system 10 includes a delivery device 12 and a cartridge 14, which is mounted to the delivery device 12. The device 12 includes a source 16 of a pressurized delivery fluid, which may be carried by a body portion 18 of the device 12. A pathway 20 fluidly connects the source 16 of pressurized fluid with an outlet 22 of a nozzle 24. Typically, the nozzle outlet will be 0.5-2 mm in diameter. This enables delivery of a spray 26 of the pressurized fluid, together with particles 28 (not to scale) from the nozzle outlet 22. The particle-containing spray 26 is applied to the teeth 30 of a person or other dentate animal. The cartridge 14 is received in or positioned adjacent to a receptacle 32 of the delivery device 12 so as to position a capsule 34 containing the particles 28 in the receptacle 32 and hence in the pathway 20. In operation, a dose of particles 28 (e.g., microparticles) is carried from the capsule 34 by the pressurized delivery fluid and through the nozzle outlet 22.

The exemplary particles 28 include a dental care agent. The dental care agent can include a tooth whitening agent, such as a bleaching agent, and/or other dental care agents, such as fluoride (NaF), antibiotics, remineralization agents, or pain relief agents (KNO₃), combinations thereof and the like. While particular reference is made herein to tooth whitening, it is to be appreciated that other applications are also contemplated.

As illustrated in FIG. 2, each capsule 34 includes a container 38 that stores a unit dose of particles 28 that contain the tooth whitening agent, i.e., sufficient particles for one whitening procedure. The container can be made from a plastic material, such as a polycarbonate, although other materials can be used. The cartridge 14 includes a tray 40 which holds a plurality of the capsules 34 at one time. While five capsules are shown, it is to be appreciated that any suitable number may be held in the tray, such as from one to ten or more, e.g., at least two. In some embodiments, the cartridge 14 is removably mounted to the device 12. When the capsules have all been used, the cartridge can be removed and a new cartridge is then fitted. In other embodiments, the cartridge tray 40 stays in position on the device 12 and is replenished with capsules 34.

The illustrated cartridge tray 40 includes upper and lower surfaces 42, 44 that are spaced by side walls 46, 48 to define a box. Opposed openings 50, 52 are formed in the upper and lower surfaces 42, 44 of the box. The openings 50, 52 are shaped to define a portion of the pathway 20, in cooperation with a side wall 56 of the capsule container 38 that is positioned between the openings. The illustrated openings 50, 52 are circular, although it is to be appreciated that other shapes are contemplated. While the illustrated openings 50, 52 are the same diameter as the capsules 34, it is also contemplated that the openings may be of a different size and/or shape to the capsules 34 and that more than one upper and/or lower opening 50, 52 may be provided. The filled capsules 34 may be fed into the tray 40 from one end 58 of the tray (or through the opening 50). In some embodiments, used capsules 34 may be ejected from the opposite end 60 of the tray (or through the opening 52), or may be stored in a portion of the tray that extends to the right of the opening (in the orientation shown in FIG. 3). The remaining capsules 34 may then be shifted in the direction of arrow A toward the end 60 so that a new capsule 34 is positioned between openings 50, 52.

The tray 40 is configured for delivering capsules 34, one at a time, into the fluid flow path and may be movable or fixed in position, relative to the device 12. An advancement mechanism 62, illustrated figuratively by an arrow, advances the capsules 34 into the flow path 20, one at a time. Any suitable drive mechanism, such as a battery operated motor or manually operated drive mechanism may be used as the advancement mechanism. In one embodiment, illustrated in FIG. 3, a spring biased or motorized drive mechanism 62 may be configured for moving the capsules 34 into position between the openings 50, 52 and for ejecting empty capsules from the tray 40. In this embodiment, the tray remains fixed, relative to the device during movement of the capsules.

In other embodiments, rather than moving the capsules relative to the tray 40, the cartridge tray 40, and the capsules within it, may be shifted in the direction of arrow A (FIG. 2) by an advancement mechanism 62. The cartridge may include a pair of openings analogous to openings 50, 52, adjacent each capsule for fluidly connecting each capsule 34 in turn with the flow path 20.

With continued reference to FIG. 2, the exemplary capsule containers 38 each include upper and lower end walls 64, 66 spaced by cylindrical side wall 56. The end walls 64, 66 of the containers and/or tray 40 is/are configured to maintain a moisture-tight seal across the ends of the containers during storage, to keep the particles dry. In one embodiment, the end walls 64, 66 may be configured to provide a moisture-tight seal to the container 38 during storage, while permitting the release of the capsules 28 and fluid flow through the container during use. For example, the end walls 64, 66 may each include a frangible membrane 68 which is broken by the fluid pressure when the capsule 34 is positioned in the pathway 20. In another embodiment, the delivery device 12 may include a member (not shown) for puncturing the end walls 64, 66 when the container 38 is or is about to be positioned in the flow path. In another embodiment, the upper and lower surfaces 42, 44 of the tray 40 may provide a seal for the upper and lower ends of the containers until each container is positioned intermediate the tray opening 50, 52. For example, the tray may be the same height (between walls 42, 44), as the containers 38 so that the walls 42, 44 tightly cover and seal the container end walls 64, 66. The capsules 34 may be from 0.01-2 cm in height h and/or width (diameter) w, such as from 0.05-0.5 cm in height and/or width.

The capsules 34 each include at least one hole that is sized to allow the particles to exit from the capsule. The hole(s) may be defined by end walls 64, 66 e.g., on in both, so that the fluid entering the capsule thorough the first of the holes and leaving the capsule through the second of the holes caries particles from the capsule. In the illustrated embodiment, the capsule upper and lower end walls 64, 66 each include one or more holes 70, which may be covered by respective membranes 68 during storage. The holes 70 permit fluid flow through the container 38 during operation. The holes(s) 70 in the upper wall 64 are of sufficient size to permit the particles 28 to escape from the container 38 into the pathway 20.

FIG. 4 illustrates another embodiment of a capsule 34, which may be similarly configured to the capsule of FIGS. 2 and 3, except as noted. In this, embodiment, the capsule includes a single opening 70, which is larger in size than the particles, in the upper surface of the capsule. The large hole enables the pulse of air/water to easily pass through the capsule and draw particles out of the capsule via pressure drops that would occur over the top of the capsule as the pulse passes through it.

As illustrated in FIG. 3, the cartridge 14 is mounted/mountable to a hollow member 72 of the delivery device 12 such that the pressurized fluid enters a suitably positioned capsule 34 (the one on the right in the drawing), in the direction of Arrow B. Any remaining capsules 34 in the tray remain moisture-tight to avoid decomposition of the whitening agent. The fluid carries the capsules from the container 38, along the pathway 20, as shown by arrow C. The exemplary hollow member 72 is a tube which terminates in the nozzle opening 22 and thus forms a part of the nozzle 24 of the device 12. However, it is also contemplated that the hollow member may be defined elsewhere in the fluid pathway, such as in the body 18 of the device. The pathway 20 may thus be defined, at least in in part, by one or more interconnected hollow members, such as hollow member 72, both within the body and/or forming part of the nozzle 24 of the device.

In some embodiments, the device may be configured to provide a first gas flow suited to use of the device 12 in a mode without the particles 28 and a second gas flow, higher than the first, suited to use of the device 12 in a mode when the whitening particles are being used. In some embodiments, the change in pressure is achieved through different nozzle designs for the two modes.

Various dental devices exist for delivery of fluids to the oral cavity which may be adapted to use for delivery of the capsules 28. As examples, delivery devices are disclosed in U.S. Pub. Nos. 2009/0305187; 2010/003520; 2010/0273125; 2010/0273126; 2010/0273127; 2010/0217671; 2011/0207078; 2011/0244418; and WO 2010/055435. Such devices have been particularly useful for cleaning of interproximal spaces. The devices often generate liquid droplets by merging liquid flowing from a reservoir into a fast-moving gas stream, such as provided by a source of compressed gas. The devices are activated by a user operating a button or the like, releasing successive bursts of compressed gas, which results in a high velocity gas stream. When this high velocity gas stream comes into contact with a flow of liquid from the reservoir, liquid droplets are produced.

The exemplary delivery device 12 can be driven by water or air or both. The delivery fluid can thus be a gas, a liquid, or combination thereof. An exemplary delivery fluid is an atomized liquid in a gas. The liquid can be water or an aqueous solution. The gas can be air, oxygen, carbon dioxide, nitrogen, or the like. In one embodiment, the fluid has sufficient pressure to cause the container 38 to open when struck by a high velocity stream of air or water, which releases the particles 28 into the flow which is then directed onto the tooth.

The device 12 includes an actuation mechanism 74, for causing the device to deliver the high pressure fluid from the fluid source 18. Any suitable actuation mechanism may be employed, such as a switch, button, or the like which directly or indirectly (e.g., via an electrical circuit, pump, a syringe with a gear operated plunger, gas cylinder release valve, or the like) causes high pressure fluid (e.g., gas) to be released by the source 18. For example, the device 12 provides pulses of gas and/or liquid at high velocity, each pulse producing sufficient force to dislodge particles from the container 38 and then direct them to the tooth in a manner similar to which an inter-dental cleaning device directs water droplets to the tooth surface. The device shown in FIG. 1 uses atomized water in pulses of air, although air jets alone could also be used to dislodge and transport the particles to the tooth surface. Each pulse of air/water removes only a small percentage of the particles, enabling the user to cover the teeth with many particles by activating the device repeatedly, e.g., via depressing a button 74, to produce many pulses of air/water.

In one embodiment, the actuation mechanism 74 may also communicate with the mechanism 62 for advancing a fresh capsule 34 into the flow path 20 at the start of a cleaning operation. In other embodiments, a separate actuator, such as a button, may be provided on the device. When the user depresses the actuator, the mechanism 62 receives a mechanical or electrical signal and pushes a new capsule 34 into position. In other embodiments, the user may actuate the mechanism 62, for example, by actuating a trigger on the device.

The source 16 of delivery fluid may include a reservoir 80, which holds a supply of water, and a gas source 82. The water from the reservoir may be delivered to the pathway by a pump, by aspiration, or other suitable mechanism. The gas source 82 may include a canister containing a pressurized gas or a mechanism for pressurizing air at atmospheric pressure. Suitable pressurizing mechanisms are disclosed, for example, in U.S. Pub. No. 2011/0244418. As an example, the pressurizing mechanism may include a syringe with a barrel containing air. A plunger, movable within the barrel, is automatically actuated by an associated gear mechanism to reduce the volume inside the syringe barrel and thereby pressurize the air before it is released into the pathway 20. Alternatively, the air maybe pressurized by a pump. A tube 86 carries the air to a mixing zone 88. A separate tube 90 carries water from the reservoir 80 to the mixing zone, where it atomizes (forms small droplets) in the air. The illustrated mixing zone 88 is in the pathway 20 upstream of the receptacle 32, such that a mixture of air and water enters the capsule 32.

The pressure of the fluid exiting the nozzle outlet 22 can be, for example, from 0-20 N/cm² (0-2 Bar), e.g., at least 1 N/cm². The gas source 82 may deliver air at a velocity of up to 600 meters per second (m/s), e.g., a velocity of at least 10 or at least 30 m/s, and in some embodiments, up to 200 or 300 m/s. The velocity and size of the water droplets can also vary. For example, the droplets may have a size in the range of 5-500 micrometers, and velocity of, for example, in a range of 10-300 meters m/s.

The device disclosed in WO 2010/055435, for example, can eject water droplets at velocities from 10 to 100 m/s, which is sufficient for delivery of the particles 28 disclosed herein, although higher or lower velocities may be appropriate in some embodiments. The force exerted on the particles 28 when impacting a hard surface, such as a tooth, can be estimated based on the average particle size and density. Assuming, for example, a particle size of 20 μm diameter and a density of 1 g/mL, each particle has a mass of approximately 30 nanograms. Taking a velocity of about 50 m/s and a deceleration distance of 10 μm, the force exerted on the particle on impact will be about 7.5 mN. This is generally sufficient to cause the particles to adhere well to the teeth, and in some embodiments, for the particles to rupture.

In some embodiments, the nozzle and or the fluid source 16 is configured for providing a higher fluid pressure when the device 12 is used for whitening than when it is used without the whitening particles. In one embodiment, the device 12 can be operated in two modes which may be achieved through two settings on the pressurization/trigger system 64 or through constrictions in the nozzle downstream of the capsule, e.g., to provide a lower velocity, longer pulse.

In one embodiment, the delivery device 12 has a first nozzle configured for delivery of fluid without the capsules and a second nozzle, interchangeable with the first nozzle, which is specifically adapted to the delivery of the capsules. For example, as shown in FIG. 5, a first nozzle 100 is configured for delivery of pressurized fluid (without microparticles) and includes a nozzle tube 102 and a hollow flange portion 104 at the base (proximal end) of the nozzle tube. Typically, nozzle tube 102 will extend outwardly from the flange portion 104, terminating in a curve, for use in interproximal cleaning The flange portion 104 includes a base portion 106 which mates around its periphery with an exteriorly-threaded opening 108 of the body portion 18. An adjacent portion 110 of the flange portion 104 is slightly larger in diameter than base portion 106. A threaded cap 112 has an opening 114 at an upper end thereof The opening 114 is large enough to permit the nozzle tube 102 to extend therethrough, but small enough so that the upper portion 110 of the flange is larger than the opening 114, thereby preventing the base 104 of the nozzle from coming out through the cap 112. The cap is interiorly threaded for engaging with the threads on threaded opening 108.

With continued reference to FIG. 5, a second nozzle 116 is interchangeable with the first nozzle 100 and is similarly configured, except as noted. The nozzle 116 includes a receptacle 32 for receiving the cartridge 14. The receptacle 32 is mounted to the upper portion 120 of a flange portion 124 (configured as for flange portion 104). The receptacle 32 may be sized and shaped to receive the cartridge therethrough while fitting through the opening 114 in the cap 112. In the second nozzle 116, the nozzle tube 72 may be somewhat wider in diameter than the nozzle tube 102 of the first nozzle, to permit passage of the capsules therethrough. Additionally, a distal end 126 of the nozzle tube 72 may be shaped or otherwise configured to deliver a spray over a wider angle than the nozzle tube 72 of the first nozzle 100. In another embodiment, an adjustable nozzle tip allows the user to adjust the spray from coarse to fine.

In some embodiments, rather than providing a separate cap 112, each nozzle 100, 116 is configured with a threaded member at the end for threadably interconnection with neck 108 of the body, or other engagement means for selectively engaging the respective nozzle with the body, to provide a fluid tight engagement between the two.

The receptacle 32 may be sized and shaped to receive the tray 40 of the cartridge 14 therein or only the capsule 34. For example, in the embodiment of FIG. 5, if the cartridge tray 14 is box-shaped, the receptacle may define a through passage 128 which is also box shaped and have a cross-section which is approximately the same dimension as the end 60 of the tray so that the tray can slide into passage to position the capsule in the flow path. The illustrated receptacle 32 includes upper and lower walls 130, 132, spaced by the passage 128. The walls 130, 132 are connected by sidewalls (not shown). Each wall 130, 132 defines an opening therethrough which forms a part of the pathway 20.

In other embodiments, the tray 40 is permanently mounted to the tube 7 and the receptacle 32 may be defined within the tube 72. For example, as illustrated in FIG. 6, the receptacle may include one or more support members 134, 136 for supporting the capsule in position in the tube 72. For example, upper and lower annular rings 134, 136, or other suitably shaped support members, may be provided which reduce the interior diameter of the tube 72. The support members may be fixed to the tube interior walls and be spaced by a distance corresponding the height of the capsule 34. A capsule can then be slid into position in the receptacle. One or more movable gates 138, 140 may seal openings in the tube that are sized to receive the capsule therethrough.

In yet other embodiments, the tray 40 may be configured for being selectively connected to the body 18 of the device. For example as shown in FIG. 7, the tray defines a cap-like member 142. The cap member 142 engages a threaded neck 108 of the body. The tray also defines a threaded neck 144, similar in shape to the neck of the body. This allows a nozzle 24, to be attached to the neck 144 via an interiorly threaded member 145 at the end thereof. Alternatively, a nozzle analogous to nozzle 100 of FIG. 5 may be used with a separate cap 112. The nozzle 24,100 may be attached directly to the neck 108 when whitening is not desired. In this embodiment, the nozzle 24 and neck 108 together serve as the receptacle 34. As will be appreciated, other engageable members are contemplated for interconnecting the tray 40 with the body 18 and with the nozzle 24 in a fluid-tight manner.

In the delivery device 12 shown in FIGS. 1 and 5-7, the receptacle 32 for the cartridge is associated with the nozzle tube 72, and is positioned downstream of the mixing zone 88 where the water and gas combine. In other embodiments, the water may be mixed with the gas in a mixing zone downstream of the capsule 34. For example, in a delivery device as shown in FIG. 8, where similar elements are accorded similar numerals, a tube 146 carries the water from the reservoir 80 to the nozzle tube and the gas and particles mix with the water at that point. In this embodiment, the gas source 82 includes a pump 147, such as a peristaltic pump, which draws gas from a container 148, although it is to be appreciated that the gas source may be similarly configured to that illustrated in FIG. 1.

In one embodiment, the velocity of the particles 28 is sufficient to cause them to rupture upon hitting the tooth. In this embodiment, the particles may be of a form that enables them to rupture upon impact. In another embodiment, the particles 28 have an outer layer which becomes permeable, e.g., thorough dissolution of the layer or components hereof, water absorption by the layer, or the like. The exemplary particles may have a density which is less than that of water, for example, less than 0.9 g/cm³ at 25° C.

The exemplary particles 28 can be dry, solid particles, which are generally spherical in shape and can be of at least 1 μm in diameter on average and can be up to 200 μm or up to 100 μm in diameter, e.g., 10-100 μm in diameter, on average, and in one embodiment, 20-50 μm on average. Each particle 28 includes a dental bleaching agent (whitening agent) protected by a moisture-resistant material. The bleaching agent may form a core of the particle, which is encapsulated in the moisture-resistant material which forms an outer layer of the particle that surrounds and protects the core from exposure to moisture during storage.

Exemplary bleaching agents are solid at ambient conditions and include carbamide peroxide, which is an adduct of urea and hydrogen peroxide (CH₄N₂O—H₂O₂). The material releases hydrogen peroxide on contact with water. Other example bleaching agent sources include alkali metal percarbonates, sodium perborate, potassium persulfate, calcium peroxide, zinc peroxide, magnesium peroxide, strontium peroxide, other hydrogen peroxide complexes, sodium chlorite, combinations thereof, and the like. The particles 28 can include bleaching agent, e.g., carbamide peroxide, at a concentration of at least 10 wt. %, such as up to about 50 wt. %. For example, at about 20 wt. %. carbamide peroxide, the hydrogen peroxide concentration per particle 28 is about 6%, which is comparable to whitening strips.

FIGS. 9-11 illustrate exemplary particles. As will be appreciated, these drawings are intended to be illustrative only and are not intended to be to scale. The particles can comprise a bleaching agent core encapsulated in a shell. The core may occupy from 1 to 99% of the volume of the microparticle, such as from 10-90%, on average. The shell may be at least 20 nm in thickness, on average, such as at least 1 μm in thickness, and in some embodiments, up to 40 μm in thickness, on average.

In the particle 28A of FIG. 9, the particle includes a core 160 formed of a bleaching agent which is encapsulated by a shell 162 of a carrier material, such as shellac, which ruptures on impact with the teeth. The shell may be entirely formed of shellac or predominantly formed of shellac, e.g., at least 50 wt. %, or at least 80 wt. %, or at least 90 wt. % shellac.

Shellac is a natural, biodegradable and renewable resin of insect origin (Kerria lacca). It consists of a mixture of polyesters including polyhydroxy polycarboxylic esters, lactones and anhydrides and the main acid components are aleuritic acid and terpenic acid.

Shellac has the features of low water permeability, and excellent film forming properties. It is enteric and listed as a food additive. Recently, methods to extract and purify shellac have significantly improved the stability of batch-to batch production and the use of an aqueous formulation of shellac (ammonium salt of shellac) has allowed elimination of the use of any organic solvents.

In one embodiment, particles 28A are formed according to the method described in Jing Xue and Zhibing Zhang, “Preparation and characterization of calcium-shellac spheres as a carrier of carbamide peroxide.” In this method, an aqueous formulation of shellac (ammonium salt of shellac) is mixed with carbamide peroxide powder to dissolve the carbamide peroxide. Droplets of the resulting mixture are then dropped from a nozzle into a cross-linking solution comprising calcium chloride in ethanol to form solid particles of calcium shellac with hydrogen peroxide encapsulated. An ice bath can be used to maintain the temperature of the cross-linking solution at 4° C. A coaxial air stream with a flow rate, for example, of 90 liters/hr can be used to pull the liquid stream from the nozzle tip to create droplets and consistent particles. After the extrusion process, the particles formed in the cross-linking solution may be transferred into a stabilization solution of calcium chloride (at 4° C.) to increase the mechanical strength of the particles. The calcium shellac particles with carbamide peroxide encapsulated can be frozen by putting them into a freezer at 25° C. for 1 hr and then dried in a freeze dryer. A vacuum pump is switched on during the freeze drying process, which may be continued for 24 hr. The temperature in the drying chamber can be maintained at 25° C. with the aid of a fan.

In another method, particles 28A are formed as described in Jing Xue and Zhibing Zhang, “Physical, Structural, and Mechanical Characterization of Calcium-Shellac Microspheres as a Carrier of Carbamide Peroxide.” In this method, an emulsification-gelation method is used in which calcium chloride powder is dispersed in an oil phase to encapsulate water-soluble carbamide peroxide. The carbamide peroxide is dissolved in shellac solution (ammonium salt of shellac). The mixture of carbamide peroxide and shellac is dispersed in an oil, such as sunflower oil by agitating the mixture, e.g., with a flat-blade disk turbine impeller at an agitation speed of 200 rpm for 30 min. CaCl₂ powder is added slowly into the dispersion. Agitation is maintained for another 2 hr. The formed microspheres settling at the bottom of the stirred vessel are then collected, washed with 2% Tween 80 solution, and dried at room temperature (about 24° C.) for 24 hr by freeze drying, as for the other method.

In other embodiments, the shell can comprise a hydrophobic material which adheres to the teeth, the particles further comprising a release rate modifier in contact with the hydrophobic material, which modifies the rate of release of bleaching agent from the particle. The hydrophobic material can comprise a waxy solid. The release rate modifier can be selected from the group consisting of polyethylene glycol, silica, water-soluble alkali metal salts, and combinations thereof.

In the particle 28B of FIG. 10, for example, the particle includes a core 166 formed of a bleaching agent which is encapsulated in a shell 168, formed of the controlled release carrier material. The controlled release carrier material in shell 168 includes a hydrophobic material, serving as a matrix, such as a wax, and a release rate modifier in contact with, e.g., dispersed in the hydrophobic material. The particle 28B adheres to the tooth and the integrity of the hydrophobic material is disrupted when the release rate modifier comes into contact with water. A ratio of the release rate modifier to hydrophobic material can be tailored to provide a slower or faster release rate of the hydrogen peroxide.

In the particle 28C of FIG. 11, the particle includes a core 170 formed of a bleaching agent which is encapsulated by a shell 172 of controlled release carrier material in the form of two layers 174, 176, the first, inner layer 174 comprising release rate modifier, and the second, outer layer 176 comprising hydrophobic material, such as a wax. The integrity of the hydrophobic material is disrupted when the particles collide with the teeth and the release rate modifier is thereby exposed and comes into contact with water. This enables a slow release of the hydrogen peroxide from the core over several hours, such as from 2-12 hours. A ratio of the release rate modifier to hydrophobic material can be tailored to provide a slower or faster release rate of the hydrogen peroxide.

The hydrophobic material used to form the shell 168, 172 of particles 28B and 28C may be a waxy solid, i.e., is solid at ambient temperature (25° C.) and may be a solid at higher temperatures. The hydrophobic material may be primarily (greater than 50%) or entirely formed from a waxy solid. Exemplary waxes suitable to use as the hydrophobic material include hydrocarbon waxes, such as paraffin wax, and the like, which are substantially or entirely free of unsaturation. Exemplary paraffin waxes are mixtures of higher alkanes of the general formula CₙH₂ₙ₊₂, where typically, 20≦n≦50. They are solid at ambient temperatures and melt-processable.

The release rate modifier used for forming the shell 168, 172 of particles 28B and 28C may be a material which is insoluble or substantially insoluble in the hydrophobic material such that it forms discrete regions where it is of high concentration in the hydrophobic material (or a separate layer 174). The discrete regions have an average size of, for example, 0.1-100 nm, e.g., 0.5-20 nm.

The release rate modifier may be more hydrophilic than the hydrophobic material. Exemplary release rate modifiers include hydrophilic organic polymers which are capable of hydrogen bonding and that are solid at ambient temperatures (25° C.), and hydrophilic and/or water soluble powders. The release rate modifier may be present in the microparticles in a total concentration of from 0.001 wt. % to 30 wt. %. Examples of hydrophilic powders include anhydrous inorganic particles, such as silicon dioxide, e.g., hydrophilic silica and silica nanopowders. Exemplary water-soluble powders include water-soluble acids and salts thereof, such as anhydrous phosphate salts, e.g., sodium polyphosphate, sodium tripolyphosphate, sodium pyrophosphate; anhydrous citric acid and salts thereof, such as alkali metals salts, e.g., sodium citrate; anhydrous sodium sulfate, anhydrous magnesium salts, such as magnesium sulfate and magnesium chloride. Combinations of such release agents may be employed. The hydrophilic and/or water soluble powders, such as silica, may have an average size of, for example, 1-100 nanometers (nm), e.g., 5-20 nm. Hydrophilic fumed silica may be obtained under the tradename AEROSIL™ from Evonik Industries with a specific surface area (measured by the BET method) in the range of 90-300 m²/g. As an example, AEROSIL™ 200 has a specific surface area of 200 m²/g.

Hydrophilic organic polymers which are useful as release rate modifiers include polyalkylene glycols, such as polyethylene glycol and polypropylene glycol, and esters thereof, polyamide compounds (e.g., polyvinylpyrrolidone), poly(vinyl acetate), poly(vinyl alcohol), poly(acrylic acid), polyacrylamide, polyoxylglycerides, such as lauroyl, oleoyl, and stearoyl polyoxylglycerides, which are mixtures of monoesters, diesters, and festers of glycerol and monoesters and diesters of polyethylene glycols (e.g., lauroyl macrogolglycerides), and ethylene oxide derivatives thereof, poloxamers, which are triblock copolymers having a central hydrophobic block of poly(propylene oxide) and two side blocks of poly(ethylene oxide) (e.g., poloxamer 188, which has a melting point 52° C.), and derivatives thereof, and mixtures thereof. The hydrophilic polymer can have a weight average molecular weight of at least 300.

Exemplary polyethylene glycols (PEG) for the release rate modifier have a molecular weight of 300 daltons to 50,000 daltons, e.g., 600-35000, or 1000 to 5,000 daltons. As examples PEG 1000 (melting point 37-40° C.), PEG 1500 (melting point 44-48° C.), PEG 2000 (melting point 49-52° C.), combinations thereof, and the like may be used.

A ratio of the hydrophobic material to release rate modifier in the particles may be, for example, from 1:99 to 99:1, expressed by weight, such as from 5:95 to 95:5 or from 10:90 to 90:10. For example, the ratio of hydrophobic material:release rate modifier may be about 30:70 to 70:30, for example, in the case of PEG. For hydrophilic and/or water soluble powders, the ratio may be higher, such as at least about 85:15.

The particles of types 28A, B, and C generally have a low water content, such as less than 5 wt. %, or less than 1 wt. %, or less than 0.2 wt. % of the particles is made up of water.

The particles of types 28A, B, and C may be used separately or combined in a container 34.

In use, a container 34 of particles is advanced into the fluid pathway 20 of the device 12, for example, by pressing the button 74. Pressing the button 74, or a separate button, causes a jet of the pressurized fluid to flow through the pathway to the container, rupturing the membrane 68, if present, and releasing the particles into the fluid flow. The particles adhere to the teeth and may rupture. The whiteness of the particles or other color, can be used as an indicator to enable the user to see where the particles have already been applied.

Particles of small size adhered to the tooth can be significantly unnoticeable by touch or sight (their color can be white), so are not a nuisance to the wearer. The user may apply the particles before going to bed so that the peroxide action on the teeth occurs overnight. Tooth brushing in the morning can remove any particulate remnants. The user may repeat the process, as needed. The device 12 acts to concentrate the particles on the tooth by repeated jets of particles projected onto the front teeth area. This provides a targeted method of peroxide application. Particles that miss the teeth will generally be at low concentrations elsewhere in the mouth. Additionally, as they will likely not have struck a hard surface, they will tend to release peroxide at a rather slow rate. Since the total concentration of peroxide in the particles of a container is controlled and quite small, the method can be considered safe for home use.

The microparticles can be formed by a variety of methods including spray cooling, precipitation, and the like. Spray cooling/chilling methods can be used where the molten hydrophobic material containing the core material is sprayed into a cold chamber or onto a cooled surface and allowed to solidify. For example, small particles of carbamide peroxide, or other bleaching agent, are combined with a molten mixture of wax and release rate modifier, e.g., PEG. The mixture is sprayed through a nozzle into a fluid at a sufficiently low temperature to solidify the mixture as microparticles. For example, carbon dioxide at low temperature may be used as the cooling fluid. Other encapsulation techniques are disclosed in MICROENCAPSULATION: Methods and Industrial Applications, Edited by Benita and Simon (Marcel Dekker, Inc., 1996).

Except where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. It is to be understood that the upper and lower amount, range, and ratio limits set forth herein may be independently combined. Similarly, the ranges and amounts for each element of the invention may be used together with ranges or amounts for any of the other elements. As used herein any member of a genus (or list) may be excluded from the claims.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A delivery device comprising:
a source of pressurized fluid;
a nozzle which defines an outlet;
a pathway which fluidly connects the source of pressurized fluid with the nozzle outlet for delivery of a spray of fluid from the nozzle outlet;
a receptacle, which receives a dose of particles, the receptacle being positioned in the pathway such that the dose of the particles is carried by the pressurized fluid and through the nozzle outlet in the spray, the particles comprising a dental care agent.

2. The delivery device of claim 1, wherein the receptacle receives an associated capsule of the particles, the pressurized fluid carrying the particles from the capsule.

3. The delivery device of claim 2, wherein the capsule includes a pair of opposed surfaces connected by a wall, at least one of the surfaces defining at least one hole, the pressurized fluid entering and leaving the capsule through the at least one hole, the capsule optionally including at least one frangible membrane which seals the at least one hole until ruptured by the pressurized fluid.

4. The delivery device of claim 2, wherein the capsule of particles is stored in an associated cartridge which holds a plurality of the capsules.

5. The delivery device of claim 4, wherein the receptacle is configured for receiving the associated cartridge.

6. (canceled)

7. The delivery device of claim 1, further comprising:
a body portion which carries the source of pressurized fluid, the body portion being selectively fluidly connectable with the nozzle.

8. The delivery device of claim 1, wherein the source of pressurized fluid comprises a source of gas and a source of liquid which are combined in a mixing zone in the pathway.

9. The delivery device of claim 1, wherein the delivery device comprises an actuation mechanism for controlling the device to supply the pressurized fluid and particles from the nozzle opening, wherein the actuation mechanism includes a pulsing mechanism for controlling the device to pulse bursts of the pressurized fluid and particles from the nozzle opening.

10. (canceled)

11. The delivery device of claim 1, wherein the delivery device has a first mode of operation in which the fluid is delivered to the fluid pathway at a first fluid pressure and a second mode of operation in which the fluid is delivered to the fluid pathway at a second fluid pressure, lower than the first fluid pressure, one of the first and second modes being employed when the device is used to deliver the dose of particles and the other of the first and second modes being employed when the device is not used to deliver the particles.

12. The delivery device of claim 1, further comprising a second nozzle interchangeable with the first nozzle, the second nozzle being configured for delivering the pressurized fluid without the particles to the teeth, optionally at a lower fluid pressure.

13. The delivery device of claim 1, wherein the dental care agent comprises a tooth whitening agent.

14. (canceled)

15. A delivery system comprising the delivery device of claim 1 and a capsule holding a dose of the particles, the receptacle being configured for positioning the capsule in the pathway.

16. A delivery system comprising the delivery device of claim 1 and a cartridge which holds a plurality of capsules, each capsule holding a dose of the particles, the cartridge being selectively connectable with the delivery device for positioning a capsule in the flow path.

17. (canceled)

18. A method for delivery of particles, comprising:
inserting a dose of particles into a delivery device, the particles comprising a dental care agent; and
actuating the delivery device to cause a flow of pressurized fluid to flow from a source of the pressurized fluid to the particles and transport the particles to a nozzle outlet of the delivery device, whereby the particles are ejected from the device in a spray of the pressurized fluid.

19. The method of claim 18, wherein the inserting of the dose of particles comprises inserting a cartridge into the device, optionally from a cartridge comprising a plurality of the capsules.

20. (canceled)
